(19) United States
(12) Patent Application Publication
(10) Pub. No.: US 2024/0360956 A1
(43) Pub. Date: Oct. 31, 2024

(54) TANK COMPRISING INNER AND OUTER ENCLOSURES AND AT LEAST ONE DUCT PASSING THROUGH SAID ENCLOSURES AND FOLLOWING A CURVED TRAJECTORY BETWEEN SAID ENCLOSURES

(71) Applicant: Airbus Operations SAS, TOULOUSE (FR)

(72) Inventors: Nicolas TOUREILLE, TOULOUSE (FR); Chloé MESIC, TOULOUSE (FR); Laure MORETTI, TOULOUSE (FR)

(21) Appl. No.: 18/644,966

(22) Filed: Apr. 24, 2024

(30) Foreign Application Priority Data
Apr. 28, 2023 (FR) 2304308

(51) Int. Cl. F17C 1/00

(52) U.S. Cl. CPC F17C 1/00; F17C 2203/03; F17C 2203/0629; F17C 2205/0311; F17C 2221/012; F17C 2223/0161; F17C 2270/0189

(57) ABSTRACT

A tank comprising an outer enclosure, an inner enclosure positioned in the outer enclosure, and at least one duct passing through first and second walls respectively fastened to the outer and inner enclosures, the tank comprising, for each duct, first and second rigid connections connecting the duct and respectively the first and second walls. Each duct comprises an intermediate segment, situated between the first and second walls, which has a curved axis such that the intermediate segment has an excess length between the first and second walls.

### CROSS-REFERENCES TO RELATED APPLICATIONS

This application claims the benefit of French Patent Application Number 2304308 filed on Apr. 28, 2023, the entire disclosure of which is incorporated herein by way of reference.

### FIELD OF THE INVENTION

The present application relates to a tank comprising inner and outer enclosures and at least one duct passing through said enclosures.

### BACKGROUND OF THE INVENTION

According to an embodiment shown in FIG. 1, a hydrogen tank 10 comprises an outer enclosure 12, an inner enclosure 14 positioned in the outer enclosure 12, thermal insulation between the outer and inner enclosures 12, 14, and two diametrically opposite connection systems 16, 16′ connecting the outer and inner enclosures 12, 14. In operation, because of the temperature and the storage pressure of hydrogen in the cryogenic state, the inner enclosure 14 may, depending on the situation, contract or expand more than the outer enclosure 12. Consequently, at least one of the two connection systems 16′ is configured to allow movement of the inner enclosure 14 with respect to the outer enclosure 12 in a direction of movement. According to one arrangement, the first connection system 16 (the one on the left in FIG. 1) is substantially rigid and does not allow any relative movement between the outer and inner enclosures 12, 14, whereas a second connection system 16′ (the one on the right in FIG. 1) allows a relative movement between the outer and inner enclosures 12, 14.

According to an embodiment shown in FIG. 2, the first connection system 16 comprises a tubular interface 18 passing through the outer and inner enclosures 12, 14 and having a first end 18.1 opening out to the outside of the outer tank 12, and a second end 18.2 opening out to the inside of the inner tank 14, each of the outer and inner enclosures 12, 14 comprising a through-hole 12.1, 14.1 to allow the tubular interface 18 to pass through. The first connection system 16 comprises a first rigid connection 20 connecting the tubular interface 18 and the outer enclosure 12, and a second rigid connection 20′ connecting the tubular interface 18 and the inner enclosure 14. According to one configuration, one of the first and second connections 20, 20′ comprises at least one flange having a first wing pressed against the outer or inner enclosure 12, 14 and connected to the latter, and a second wing pressed against the tubular interface 18 and connected to the latter. In addition, the first connection system 16 comprises a first closure plate 22.1 closing the first end 18.1 of the tubular interface 18, and a second closure plate 22.2 closing the second end 18.2 of the tubular interface 18.

The hydrogen tank 10 comprises a plurality of ducts 24, 24′ which pass through the first and second closure plates 22.1, 22.2 and which each have a first end 24.1, 24.1′ opening into the inner enclosure 14. All of these ducts 24, 24′ are rectilinear between the first and second closure plates 22.1, 22.2.

Each of the first and second closure plates 22.1, 22.2 comprises, for each duct 24, 24′, an orifice 26 to allow the duct 24, 24′ to pass through said first or second closure plate 22.1, 22.2. In line with each orifice 26, each duct 24, 24′ is connected to the first or second closure plate 22.1, 22.2 by a weld seam 28 which connects the duct 24, 24′ to the first or second closure plate 22.1, 22.2 in a sealed manner around the entire periphery of the duct 24, 24′.

In one embodiment, the materials of the various elements (enclosures, ducts, closure plates, connection systems) may be different: for example, metallic/composite.

In operation, taking into account:
the pressure in the inner enclosure 14,
the difference in thermal expansion between the materials of the ducts 24, 24′ and of the connection system 16,
the very considerable difference in temperature between, on the one hand, the outer enclosure 12 and the first closure plate 22.1 and, on the other hand, the inner enclosure 14 and the second closure plate 22.2,

the ducts 24, 24′, the weld seams 28 and the inner and outer enclosures are subjected to considerable stresses that can damage them.

### SUMMARY OF THE INVENTION

The present invention aims to overcome all or some of the drawbacks of the prior art.

To this end, the invention relates to a tank comprising an outer enclosure, an inner enclosure positioned in the outer enclosure, first and second connection systems connecting the outer and inner enclosures, a first wall fastened to or forming part of the outer enclosure, a second wall fastened to or forming part of the inner enclosure, and at least one duct passing through the first and second walls. In addition, the first and second walls comprise, for each duct, respectively first and second orifices to allow the duct to pass through them; the tank comprising, for each duct, first and second rigid connections connecting the duct and respectively the first and second walls, each duct comprising an intermediate segment situated between the first and second walls.

According to the invention, the intermediate segment has a curved axis such that the intermediate segment has an excess length between said first and second walls.

The excess length of the intermediate segment makes it possible to compensate for a dimensional variation between the first and second walls and to limit stresses on the first and second connections in order to reduce the risks of damage to the ducts and said first and second connections.

According to another feature, the intermediate segment has an axis which follows a trajectory in the form of a circular helix.

According to another feature, the first and second walls are substantially parallel to each other and angularly offset by about 180°.

According to another feature, the tank comprises a plurality of ducts passing through the first and second walls and comprising intermediate segments which follow trajectories in the form of a circular helix having approximately the same helix axis. According to another feature, the first connection system comprises:
a tubular interface passing through the outer and inner enclosures, connected thereto and having a first end opening out to the outside of the outer enclosure and a second end opening out to the inside of the inner enclosure,
a first closure plate closing the first end of the tubular interface and forming the first wall,
a second closure plate closing the second end of the tubular interface and forming the second wall.

The invention also relates to an aircraft comprising at least one tank according to one of the preceding features.

### BRIEF DESCRIPTION OF THE DRAWINGS

Other features and advantages will become apparent from the following description of the invention, the description being given solely by way of example, with reference to the appended drawings, in which:

FIG. 1 is a longitudinal section of a tank, illustrating an embodiment of the prior art;

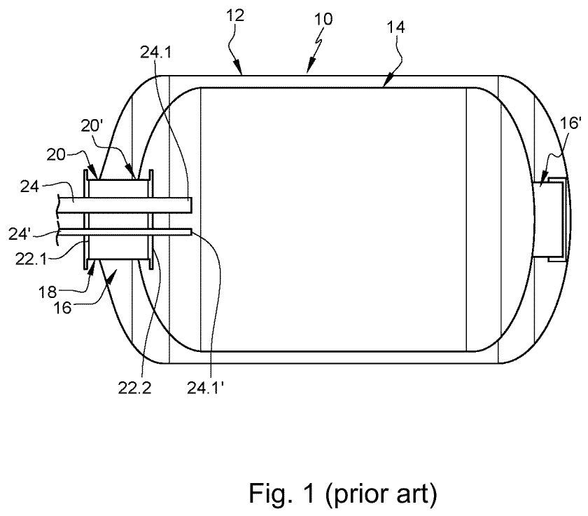

FIG. 2 is a longitudinal section of a connection system, connecting outer and inner enclosures of the tank shown in FIG. 1, illustrating an embodiment of the prior art;

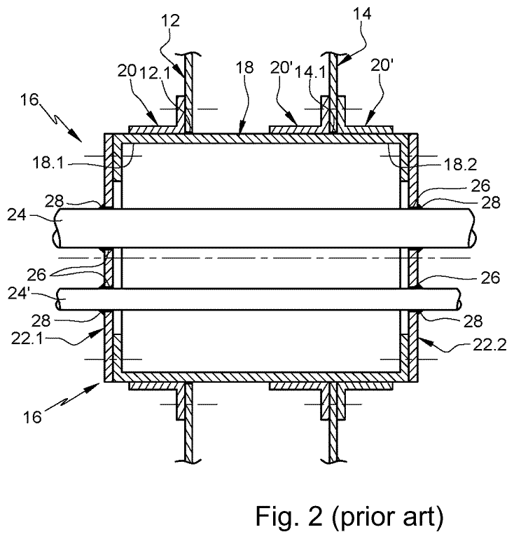

FIG. 3 is a longitudinal section of a connection system, connecting outer and inner enclosures of a tank, illustrating an embodiment of the invention;

FIG. 4 is a perspective view of a connection system, connecting outer and inner enclosures of a tank, illustrating an embodiment of the invention;

FIG. 5 is a front view of a first closure plate, illustrating an embodiment of the invention; and,

FIG. 6 is a front view of a second closure plate, illustrating an embodiment of the invention.

### DETAILED DESCRIPTION OF THE PREFERRED EMBODIMENTS

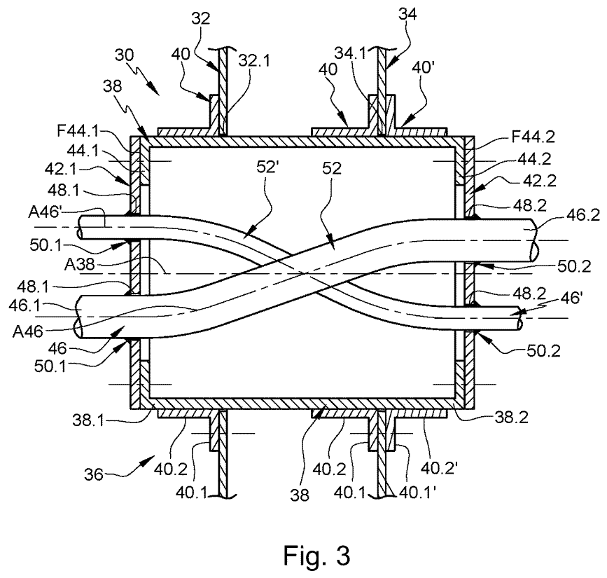

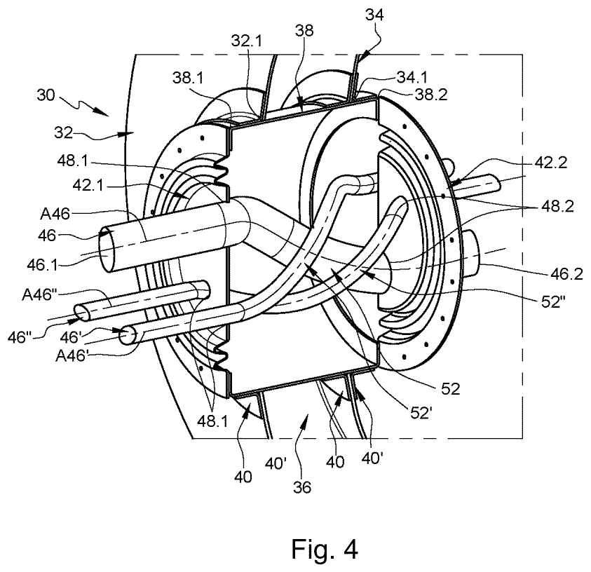

According to an embodiment shown in FIGS. 3 and 4, a tank 30 comprises an outer enclosure 32, an inner enclosure 34 positioned in the outer enclosure 32, and two diametrically opposite connection systems 36 connecting the outer and inner enclosures 32, 34. According to one configuration, the tank 30 can comprise thermal insulation between the outer and inner enclosures 32, 34.

According to one arrangement, the first connection system 36 is substantially rigid, whereas the second connection system (not shown) allows a relative movement between the outer and inner enclosures 32, 34. The second connection system is configured to allow a relative movement, between the outer and inner enclosures 32, 34, oriented in a longitudinal direction.

According to one application, an aircraft comprises at least one tank 30 used to store a fluid in the cryogenic state, such as hydrogen. Of course, the invention is not limited to this application.

The first connection system 36 comprises a tubular interface 38 passing through the outer and inner enclosures 32, 34, connected thereto and having a first end 38.1 opening out to the outside of the outer enclosure 32 and a second end 38.2 opening out to the inside of the inner enclosure 34, each of the outer and inner enclosures 32, 34 comprising a through-hole 32.1, 34.1 to allow the tubular interface 38 to pass through. The tubular interface 38 has an axis of revolution A38 parallel to the longitudinal direction.

According to one configuration, the first connection system 36 comprises, for the inner enclosure 34, two L-shaped flanges 40, 40′ positioned on either side of the inner enclosure 34, each flange 40, 40′ comprising a first wing 40.1, 40.1′ pressed against the inner enclosure 34 and connected to the latter, and a second wing 40.2, 40.2′ pressed against the tubular interface 38 and connected to the latter. The first connection system 36 also comprises, for the outer enclosure 32, a flange 40 positioned outside the outer enclosure 32, comprising a first wing 40.1 pressed against the outer enclosure 32 and connected to the latter and a second wing 40.2 pressed against the tubular interface 38 and connected to the latter. Of course, the invention is not limited to this configuration for the connections between the tubular interface 38 and the outer and inner enclosures 32, 34.

The first connection system 36 comprises a first closure plate 42.1 closing the first end 38.1 of the tubular interface 38, and a second closure plate 42.2 closing the second end 38.2 of the tubular interface 38. According to one configuration, the tubular interface 38 comprises a first collar 44.1 at its first end 38.1, and a second collar 44.2 at its second end 38.2, each of the first and second collars 44.1, 44.2 having a contact face F44.1, F44.2, positioned in a transverse plane perpendicular to the axis of revolution A38, against which the corresponding closure plate 42.1, 42.2 is pressed. Of course, the invention is not limited to this embodiment for the tubular interface 38.

The hydrogen tank 30 comprises at least one duct 46 which passes through the first and second closure plates 42.1, 42.2 and which comprises a first end 46.1 opening out to the outside of the outer enclosure 32, and a second end 46.2 opening out into the inner enclosure 32.

For each duct 46, the first closure plate 42.1 comprises a first orifice 48.1 to allow the duct 46 to pass through said first closure plate 42.1. In addition, the tank 30 comprises a first connection 50.1 connecting the duct 46 and the first closure plate 42.1.

For each duct 46, the second closure plate 42.2 comprises a second orifice 48.2 to allow the duct 46 to pass through said second closure plate 42.2. In addition, the tank 30 comprises a second connection 50.2 connecting the duct 46 and the second closure plate 42.2.

The first and second connections 50.1, 50.2 are rigid connections. Each of them is a leaktight connection providing fluid tightness between the duct 46 and the first or second closure plate 42.1, 42.2. By way of example, each of the first and second connections 50.1, 50.2 comprises at least one weld seam surrounding the duct 46 and providing leaktightness between the latter and the closure plate 42.1, 42.2. Of course, the invention is not limited to this embodiment for the first and second rigid connections 50.1, 50.2. By way of example, the first or second connection 50.1, 50.2 could be in the form of a flange.

The tubular interface 38 and the closure plates 42.1, 42.2 are not described in any more detail as they can be identical to those of the prior art.

Each duct 46 comprises an intermediate segment 52 situated between the first and second closure plates 42.1, 42.2.

According to one feature of the invention, the intermediate segment 52 has a curved axis A46. Thus, contrary to the prior art, the axis A46 is not rectilinear between the first and second closure plates 42.1, 42.2 so that the intermediate segment 52 of the duct 46 has an excess length between said first and second closure plates 42.1, 42.2. This excess length corresponds to the difference in length between, on the one hand, the length of the intermediate segment 52 considered along its curved axis A46 and, on the other hand, the distance between the closure plates 42.1 and 42.2 considered along the axis of revolution A38.

In operation, the outer enclosure 34 and the first closure plate 42.1 are in contact with an environment at ambient temperature, while the inner enclosure 34, the second closure plate 42.2 and the segment of the duct 46 situated in the inner enclosure 34 are in contact with a fluid at a cryogenic temperature, much lower than the ambient temperature. This temperature difference causes deformations of unequal values for at least two elements from among the inner and outer enclosures 32, 34, the duct 46 and the first and second closure plates 42.1, 42.2. This tends to modify the spacing between the first and second closure plates 42.1, 42.2 at the first and second orifices 48.1, 48.2 and consequently to generate considerable stresses in at least one of the abovementioned elements. The excess length of the intermediate segment 52 of the duct 46 makes it possible to compensate for this dimensional variation between the first and second closure plates 42.1, 42.2, to limit the stresses on the first and second connections 50.1, 50.2, and to reduce the risks of damage to said first and second connections 50.1, 50.2.

According to one configuration, the axis A46 of the intermediate segment 52 follows a trajectory in the form of a circular helix at least between the first and second closure plates 42.1, 42.2.

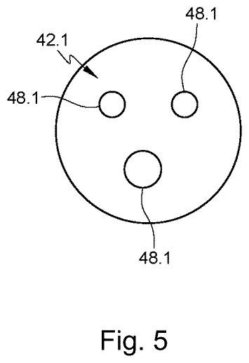

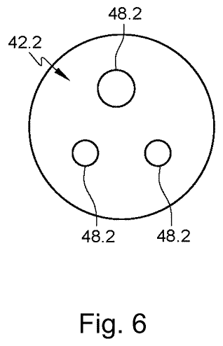

According to one arrangement, the first and second closure plates 42.1, 42.2 are substantially parallel to each other and angularly offset by about 180°. Consequently, if the first orifice 48.1 of the first closure plate 42.1 is situated at 6 o'clock, as illustrated in FIG. 5, the second orifice 48.2 of the second closure plate 42.1 is situated at 12 o'clock, as illustrated in FIG. 6.

According to one embodiment, the tank 30 comprises a plurality of ducts 46, 46′, 46″ which pass through the first and second closure plates 42.1, 42.2, each of them comprising an intermediate segment 52, 52′, 52″ which has a curved axis A46, A46′, A46″. According to a configuration shown in FIG. 4, all the intermediate segments 52, 52′, 52″ follow trajectories in the form of a circular helix having approximately (i.e., +/−10%) the same helix axis, at least between the first and second closure plates 42.1, 42.2.

Of course, the invention is not limited to the embodiments described above. The first and second closure plates 42.1, 42.2 could be positioned in line with the walls of the outer and inner enclosures 32, 34, respectively. Whatever the embodiment, the tank 30 comprises a first wall 42.1 fastened to or forming part of the outer enclosure 32, a second wall 42.2 fastened to or forming part of the inner enclosure 34, and at least one duct 46 passing through the first and second walls 42.1, 42.2. For each duct 46, the first and second walls 42.1, 42.2 respectively comprise first and second orifices 48.1, 48.2 to allow the duct 46 to pass through the first and second walls 42.1, 42.2. In addition, the tank 30 comprises, for each duct 46, first and second rigid connections 50.1, 50.2 connecting the duct 46 and respectively the first and second walls 42.1, 42.2.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A tank comprising:
an outer enclosure,
an inner enclosure positioned in the outer enclosure,
first and second connection systems connecting the outer and inner enclosures,
a first wall fastened to or forming part of the outer enclosure,
a second wall fastened to or forming part of the inner enclosure, and
at least one duct passing through the first and second walls, the first and second walls comprising, for each duct, respectively, first and second orifices to allow the duct to pass therethrough,
wherein the tank further comprises, for each duct, first and second rigid connections connecting the duct and, respectively, the first and second walls,
wherein each duct comprises an intermediate segment situated between the first and second walls,
wherein that the intermediate segment has a curved axis such that the intermediate segment has an excess length between said first and second walls, and
wherein the intermediate segment has an axis which follows a trajectory of a circular helix.

2. The tank as claimed in claim 1, wherein the first and second walls are substantially parallel to each other and angularly offset by about 180°.

3. The tank as claimed in claim 1, further comprising:
a plurality of ducts passing through the first and second walls and comprising intermediate segments which follow trajectories of a circular helix having approximately the same helix axis.

4. The tank as claimed in claim 1, wherein the first connection system comprises:
a tubular interface passing through the outer and inner enclosures, connected thereto and having a first end opening out to an outside of the outer enclosure, and a second end opening out to an inside of the inner enclosure,
a first closure plate closing the first end of the tubular interface and forming the first wall, and,
a second closure plate closing the second end of the tubular interface and forming the second wall.

5. An aircraft comprising:
the tank as claimed in claim 1.
